(19) United States
(12) Patent Application Publication
(10) Pub. No.: US 2004/0020533 A1
(43) Pub. Date: Feb. 5, 2004

(54) Low permeation weldable fuel tank valve

(76) Inventor: Brian Engle, Armada, MI (US)

Correspondence Address: Dickinson Wright PLLC, Suite 800, 1901 L. Street NW, Washington, DC, 20036, US

(21) Appl. No.: 10/440,874

(22) Filed: May 19, 2003

Related U.S. Application Data
(60) Provisional application No. 60/400,590, filed on Aug. 2, 2002.

(51) Int. Cl. F16K 24/04

(52) U.S. Cl. 137/202

(57) ABSTRACT

A conduit for use with a polymeric fuel tank. The conduit attaches to a fuel tank and includes an outlet port having first retention barb formed from a layer capable of being welded to a fuel tank and a second retention barb formed from a permeation resistant layer. When welded to the fuel tank, the permeation resistant layer may be spaced from the weldable surface of the fuel tank to prevent contamination of any weld joint.

### CROSS-REFERENCE TO RELATED APPLICATION

This application claims the benefit of U.S. Provisional Application No. 60/400,590, filed Aug. 2, 2002, the entire disclosure of this application being considered part of the disclosure of this application and hereby incorporated by reference.

### BACKGROUND OF THE INVENTION

The present invention relates to fuel tank outlet ports and more particularly to vapor venting fuel tank valves suitable for use with fuel tanks constructed of polymeric materials.

Historically, fuel tanks were formed from metal, which were subject to corrosion problems and added weight to a vehicle. To reduce these problems, manufacturers switched to polymer fuel tanks and valves. Polymer fuel tanks and vapor valves are formed from materials such as polyethylene, polypropylene, and other useful thermoplastic materials. Polymer vapor valves are easily assembled to polymer fuel tanks because the vapor valve may be directly welded to the fuel tank. One problem with most polymeric materials suitable for fuel tanks and vapor valves is that most polymeric materials allow fuel vapor to permeate.

To reduce permeation, manufacturers have added permeation resistant layers to fuel tanks and to further reduce permeation, manufacturers have added permeation resistant layers to vapor valves or formed the vapor valves from a permeation resistant material. Vapor valves formed out of a permeation resistant material, such as acetal or nylon, provide a good permeation barrier, but are difficult to attach to the fuel tank because permeation resistant materials generally are difficult to securely bond to the fuel tank. To attach permeation resistant valves to a fuel tank, typically a weldable cover formed out of a material similar to the outer layer of the fuel tank is used so that the weldable cover may be welded directly to the fuel tank. Problems associated with weldable covers include increased manufacturing cost, increased assembly time, as well as the creation of permeation and fuel migration pathways between the weldable cover and the permeation resistant valve body.

To overcome some of the above problems, manufacturers have started to use overmolded vapor valves. Overmolded vapor valves have an outer layer formed from a material that is weldable to the fuel tank and an inner permeation barrier layer to reduce permeation. Overmolded vapor valves reduce permeation and are generally easy to manufacture. Problems with overmolded vapor valves still include the presence of permeation and fuel migration pathways.

Vapor valves are typically attached to an evaporative emission container with a tube having a permeation resistant lining. The tube is attached to the outlet port on the vapor valve and generally retained by retention barbs on the outlet port. The retention barbs are typically formed from the outer weldable layer, usually a form of polyethylene. Because the inner permeation resistant lining within the tube is only in contact with the retention barbs formed out of the weldable layer on the fuel vapor valve, fuel vapors may permeate from within the tube. This permeation pathway can transmit up to five to seven milligrams of fuel vapor per day. Another problem with these vapor valves is fuel migration between the permeation resistant layer and the weldable layer. This may allow fuel migration from within the tank to the tube. Leakage between these layers may be increased due to different fuel swell rates and thermal expansion rates, which may result in gaps between the permeation resistant layer and the weldable layer. Any fuel migration between the layers to within the tube may overcome the evaporative emissions container.

To address the above permeation pathways, some manufacturers form the retention barb or barbs out of the permeation resistant layer. These designs are still problematic due to the potential fuel migration between the permeation resistant layer and weldable layer of the overmolded valve. Because it is generally difficult to attach or bond the inner permeation resistant layer to any other material, such as the permeation resistant layer in the tank, these gaps or pathways may permit fuel migration from the base of the fuel vapor valve in the tank directly into the surrounding environment.

### SUMMARY OF THE INVENTION

The aforementioned problems are overcome in the present invention wherein a conduit attached to a fuel tank includes an outlet port having first retention barb formed from a layer capable of being welded to a fuel tank and a second retention barb formed from a permeation resistant layer. When welded to the fuel tank, the permeation resistant layer may be spaced from the weldable surface of the fuel tank to prevent contamination of any weld joint.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a perspective view of a conduit attached to a fuel tank;

FIG. 2 is a front elevational view of the conduit;

FIG. 3 is a partial sectional view of the conduit and attached tube taken along line 33 in FIG. 1;

FIG. 4 is a partial front elevational view of a first alternative embodiment of the outlet port;

FIG. 5 is a partial front elevational view of a second alternative embodiment of the outlet port; and

FIG. 6 is a partial front elevational view of a third alternative embodiment of the outlet port.

### DETAILED DESCRIPTION OF THE PREFERRED EMBODIMENT

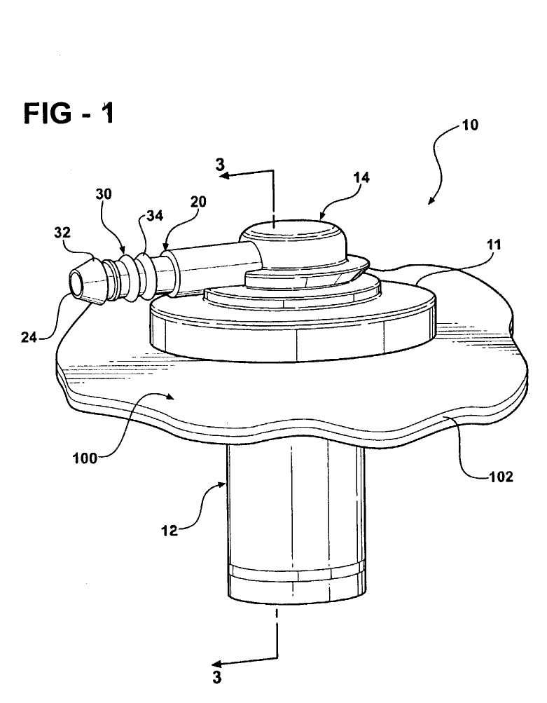

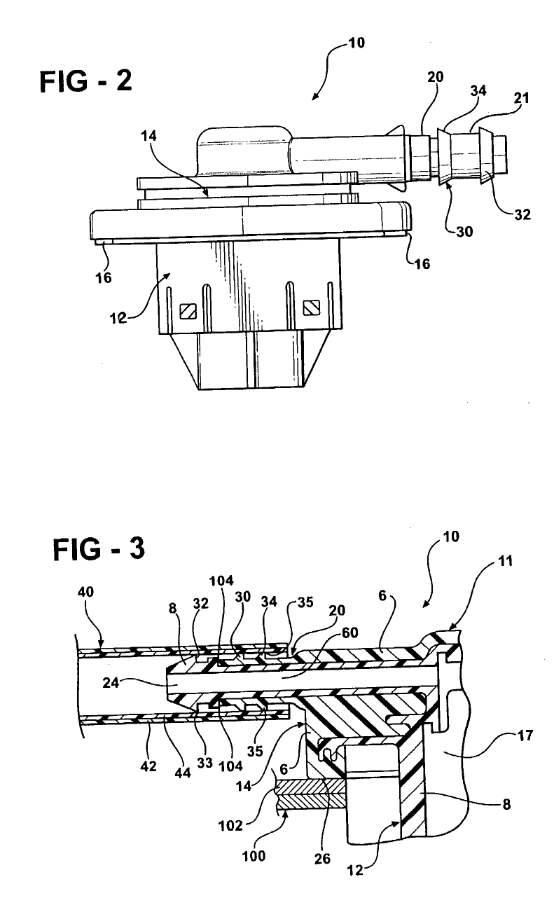

A conduit constructed in accordance with the invention is illustrated in FIG. 1 as a fuel tank vapor valve assembly 10. The vapor valve assembly 10 includes a vapor valve body 11 attached to a fuel tank 100 and is connected to an evaporative emissions container (not shown) with a tube 40, generally including a permeation resistant lining 44 (FIG. 2). The vapor valve body 11 is generally formed with an outer weldable layer 6 overmolded onto an inner permeation resistant layer 8. The vapor valve 11 may also be divided into a lower portion 12 and an upper portion 14. The lower portion 12 generally contains the operative chambers 17 of the valve 10, in a manner known in the art, while the upper portion 14 includes an outlet port 20 to which the tube 40 is attached. The outlet port 20 generally includes an outer retention barb 32 formed from the weldable layer 6 and a second retention barb 34 formed from the permeation resistant layer 8. The permeation resistant layer 8 and weldable layer 6 meet between the retention barbs 32, 34 to form a mating joint 104. Even though the present invention is described as a fuel tank vapor valve 11, the present invention may be directed to any conduit attached to a fuel tank 100 that includes an outer and inner retention barb 32, 34 with a mating joint 104 therebetween.

The outer weldable layer 6 is overmolded onto the inner permeation resistant layer 8 and generally formed from the same material as the fuel tank 100 or an outer layer 102 of the fuel tank. The outer weldable layer 6 and inner permeation resistant layer 8 join to form a mating joint 104 (FIG. 3). In the illustrated embodiment, the weldable layer 6 is formed from a polyethylene, such as a high-density polyethylene, but other materials that allow the vapor valve body 11 to be welded to the fuel tank 100 may also be used. The inner permeation resistant layer 8 is formed from a permeation resistant material having a fuel vapor permeation rate that is less than the permeation rate of the weldable material 6. One skilled in the art would recognize that it is generally desirable to use materials that minimize permeation, such as materials with hydrocarbon permeation rates approaching zero mg hydrocarbon emissions per day and dimensionally stable when exposed to fuel or fuel vapors. In the illustrated embodiment, the permeation resistant inner layer 8 is formed from nylon or acetal having a permeation rate on the order of less than 3 mg hydrocarbon emissions per day. Other examples of suitable materials for the permeation resistant inner layer 8 include any plastic or metal-based materials that have suitable chemical resistance to fuel vapors and permeation rates below applicable vapor emission regulations.

The lower portion 12 and upper portion 14 may be formed in any size, shape, or configuration acceptable for vapor valves. The lower portion 12 may be formed from the same material as the permeation resistant inner layer 8, both the permeation resistant layer and outer weldable layer 6 or from other materials. In the illustrated embodiment, the lower portion 12 is formed only from the permeation resistant inner layer 8 in order to simplify manufacturing (FIG. 3). A passageway 60 passes from the operative chambers 17 within the lower portion 12 and through upper portion 14 to exit at a discharge port 24. The operative chambers 17 may be formed in almost any size or configuration, for example, the operative chambers 17 may be sized and shaped to receive valve components such as a float housing, a sealing orifice, float, a bias spring, and any other components known in the art to be desirous for operation of a valve.

The upper portion 14 is formed from both the outer weldable layer 6 and permeation resistant layer 8. The outer weldable layer 6 generally includes at least one welding rib 16 for securing the valve body 11 to the fuel tank 100. The welding ribs 16 are preferably arranged in a circumferential pattern, but may be formed in almost any shape or configuration, as is well known in the art. Other methods of securing the valve body 11 to the fuel tank 100 may also be used.

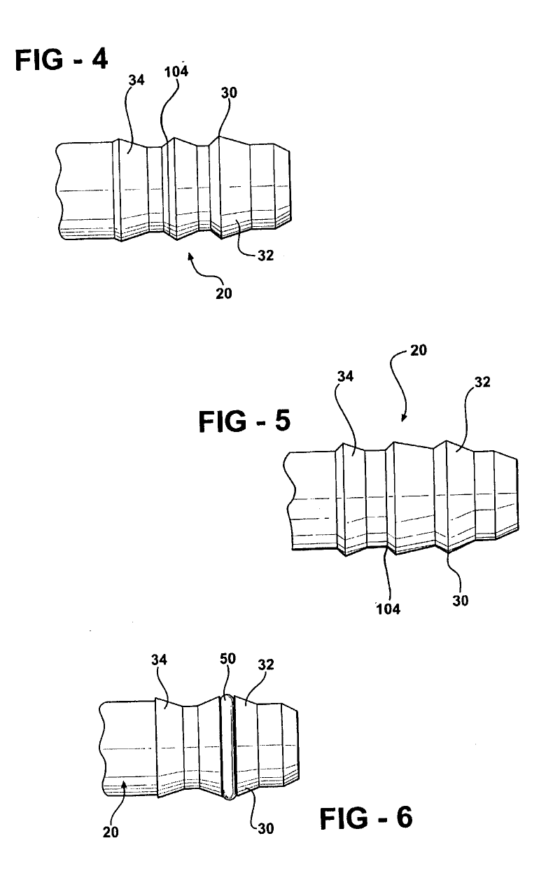

The outlet port 20 on the upper portion 14 is configured to be inserted into the tube 40. In the illustrated embodiment, the outlet port 20 surrounds the passageway 60 and includes retention barbs 30 and a discharge port 24 at the exit end of the passageway 60. The retention barbs 30 may be arranged in various configurations, sizes, and shapes as shown in FIGS. 2-5, to couple the tube 40 to the valve body 11 and minimize permeation as well as fuel migration. Generally, any radial protrusion from the outlet port 20 may constitute retention barbs 30. In general, the outlet port 20 defines an outer surface 21 including said weldable layer 6 and said permeation resistant layer 8. A clamp (not shown), such as a hose clamp or spring clip, may be used to further secure the tube 40 to the outlet port 20. At least one of the retention barbs 30 on the outer surface of the outlet port 20 is formed from the permeation resistant inner layer 8. In the illustrated embodiment, the outer retention barb 32, nearest to the discharge port 24, is formed from the permeation resistant inner layer 8 while the inner retention barb 34, farthest from the discharge port 24, is formed from the outer weldable layer 6, as shown in FIG. 3. Additional retention barbs 30 formed from either the permeation resistant layer 8 or the outer weldable layer 6 may be added between the outer retention barb 32 and inner retention barb 34.

The tube 40 may have a variety of configurations and is well known in the art. In the illustrated embodiment, the tube 40 (FIG. 2) includes a flexible layer 42 and the permeation resistant inner lining 44. The permeation resistant inner lining 44 may be formed from materials having low permeation rates such as ethylene vinyl alcohol (EVOH) or Teflon. In the illustrated embodiment, the tube 40 fits over the retention barbs 30 so that the retention barbs 30 are in direct contact with the permeation resistant lining 44 on the tube 40. As shown in FIG. 3, the permeation resistant lining 44 is in direct contact with both the outer retention barb 32, formed from the inner permeation resistant layer 8, and the inner retention barb 34, formed from the outer weldable layer 6. More specifically, the outer retention barb 32 forms a primary sealing surface 33 and the inner retention barb 34 forms a secondary sealing surface 35. The contact illustrated in FIG. 3 between permeation resistant lining 44 of the tube 40 and retention barbs 30, specifically the primary sealing surface 33 and secondary sealing surface 35, forms circumferential seals that either prevent permeation of fuel vapors or provide a tortuous pathway that limits permeation. The contact between the inner retention barb 34 and the permeation resistant lining 44 of the tube 40 also minimizes permeation and fuel migration from within the tube and from the mating joint 104. In some embodiments, the valve 10 may be formed without retention barbs 30, so long as the permeation resistant lining 44 on the tube 8 is in contact with both the inner permeation resistant layer 8 and outer weldable layer 6 on the outlet port 20.

The vapor valve body 11 is generally formed by injection molding the inner permeation resistant layer 8 to form the valve body 11 and outlet port 20 as a single unit. More specifically, two core pins are placed in a mold so that the pins meet at the desired angle. A material that is dimensionally stable in the presence of fuel and fuel vapors, such as plastics that are chemically resistant to fuel vapors, is then injected into the die. A variety of other processes well known in the art, such as extrusion or injection molding may also be used to form the permeation resistant inner layer 8. The outer weldable layer 6 is then formed over the inner permeation resistant layer 8 by placing the inner permeation resistant layer 8 in a second die and injecting a material that is weldable to the fuel tank, such as a polyethylene. To limit contamination in the bond area 26 during welding the vapor valve body 11 to the fuel tank 100, as described below, the outer weldable layer 6 surrounds the inner permeation resistant layer 8 near the bond area 26, preventing the inner permeation resistant layer 8 from melting and contaminating the bond area 26 (FIG. 3). After the vapor valve body 11 is formed, the desired valve inner components are placed in the valve body.

The vapor valve body 11 is then attached to a fuel tank as is well known in the art, such as by welding the vapor valve to the fuel tank. A permeation resistant tube 40, having an exposed permeation resistant lining 44, is then fit over the outlet port 20 on the vapor valve 11. The tube 40 is installed so that the exposed permeation resistant lining 44 contacts the inner permeation resistant layer 8 and outer weldable layer 6 on the vapor valve 10.

An alternative embodiment may be seen in FIG. 5 where an O-ring 50 is included on the vapor valve outlet port 20 to provide additional resistance to permeation. The O-ring 50 is preferably formed from a permeation resistant material such as a fluorine based copolymer. To increase resistance to fuel migration and permeation from the mating joint 104, the O-ring 50 may be positioned so as to seal the mating joint 104 by being in contact with both the inner permeation resistant layer 8 and the outer weldable layer 6. The foregoing discussion discloses and describes an exemplary embodiment of the present invention. One skilled in the art will readily recognize from such discussion, and from the accompanying drawings and claims, that various changes, modifications and variations can be made therein without departing from the true spirit and fair scope of the invention as defined by the following claims.

What is claimed is:

1. A fuel tank vapor valve assembly comprising:
a vapor valve body having an outlet port including a weldable layer and a permeation resistant layer, said weldable layer defining a first retention barb and said permeation resistant layer defining a second retention barb.

2. The fuel tank vapor valve assembly of claim 1 further including a fuel tank and wherein said weldable layer is coupled to said fuel tank to form a bond area, said weldable layer being disposed between said permeation resistant layer and said fuel tank in said bond area.

3. The fuel tank vapor valve assembly of claim 1 further including a tube having a permeation resistant inner lining contacting said first retention barb and said second retention barb.

4. The fuel tank vapor valve assembly of claim 1 further including an O-ring coupled to said outlet port.

5. The fuel tank vapor valve assembly of claim 4 wherein said O-ring contacts said permeation resistant layer and said weldable layer.

6. The fuel tank vapor valve assembly of claim 1 wherein said permeation resistant layer has a permeation rate approximately less than 3 mg hydrocarbon emissions per day.

7. The fuel tank vapor valve assembly of claim 1 further including a fuel tank having a weldable surface, said weldable layer coupled to said weldable surface.

8. The fuel tank vapor valve assembly of claim 7 wherein said permeation resistant layer is spaced from said weldable surface when said weldable layer is coupled to said weldable surface.

9. A fuel tank assembly comprising:
a fuel tank having a weldable surface; and
a fuel tank vapor valve having a weldable layer and a permeation resistant layer, said permeation resistant layer being spaced from said weldable surface of said fuel tank, said weldable layer coupled to said weldable surface.

10. The fuel tank assembly of claim 9 wherein said fuel tank vapor valve further includes an outlet port having an outer surface including said weldable layer and said permeation resistant layer.

11. The fuel tank assembly of claim 10 further including a tube having a permeation resistant inner lining, said tube being coupled to said outlet port.

12. The fuel tank assembly of claim 11 wherein said tube contacts said weldable layer and said permeation resistant layer of said outlet port.

13. The fuel tank assembly of claim 12 wherein said weldable layer on said outer surface includes an inner retention barb and said permeation resistant layer includes an outer retention barb, said retention barbs being coupled to said tube.

14. The fuel tank assembly of claim 13 wherein said outer retention barb and said tube form a primary sealing surface and said inner retention barb and said tube form a secondary sealing surface.

15. The fuel tank assembly of claim 9 wherein said permeation resistant layer has a permeation rate approximately less than 3 mg per day.

16. A fuel tank assembly comprising:
a fuel tank having a weldable surface;
a conduit coupled to said weldable surface and having a discharge port, a first retention barb formed from a weldable layer, and a second retention barb formed from a permeation resistant layer, and wherein said permeation resistant layer and said weldable layer form a mating joint between said first and second retention barbs.

17. The fuel tank assembly of claim 16 wherein said permeation resistant layer has a permeation rate approximately less than 3 mg per day.

18. The fuel tank assembly of claim 16 further including a tube coupled to said conduit and having a permeation resistant lining engaging said first and second retention barbs.

19. The fuel tank assembly of claim 16 wherein said conduit is a fuel vapor valve.
